(19) United States
(12) Patent Application Publication
(10) Pub. No.: US 2015/0311934 A1
(43) Pub. Date: Oct. 29, 2015

(54) COMMUNICATION METHOD, ELECTRONIC DEVICE, AND STORAGE MEDIUM

(71) Applicant: Samsung Electronics Co., Ltd., Gyeonggi-do (KR)

(72) Inventors: In-Hwan JANG, Seoul (KR); Suk-Whan KIM, Seoul (KR); In-Soo KIM, Seoul (KR); Jeong-Hun KIM, Gyeonggi-do (KR)

(73) Assignee: Samsung Electronics Co., Ltd.

(21) Appl. No.: 14/699,469

(22) Filed: Apr. 29, 2015

(30) Foreign Application Priority Data
Apr. 29, 2014 (KR) 10-2014-0051671

(51) Int. Cl. H04B 1/3816; H04W 68/00; H04W 12/06

(52) U.S. Cl. CPC H04B 1/3816; H04W 12/06; H04W 68/005

(57) ABSTRACT

A communication method for a first electronic device is provided. The communication method includes receiving, from a second electronic device, second subscriber information stored in a second subscriber identification module of the second electronic device, receiving second response information generated based on second authentication information from the second electronic device, and transmitting the second response information to a communication network.

### PRIORITY

This application claims priority under 35 U.S.C. §119(a) to Korean Patent Application Serial No. 10-2014-0051671, which was filed in the Korean Intellectual Property Office on Apr. 29, 2014, the entire content of which is incorporated herein by reference.

### BACKGROUND OF THE INVENTION

1. Field of the Invention

The present disclosure generally relates to an electronic device having a communication function, and more particularly, to a communication method and apparatus using a subscriber identification module.

2. Description of the Related Art

An electronic device (for example, a smart phone) may provide various application functions such as a clock, a calendar, a notepad, searching, a map, news, a real-time camera, as well as a communication function. A user may use the various functions of the electronic device.

The user may have several electronic devices and perform communication using a first electronic device or a second electronic device among the electronic devices.

The user may also have several electronic devices (for example, a smart phone, a smart watch, and/or the like) and may intend to communicate with another electronic device at a phone number of a second electronic device by using a first electronic device among the electronic devices.

However, conventionally, the user may not communicate with another electronic device at the phone number of the second electronic device by using the first electronic device.

### SUMMARY OF THE INVENTION

The present disclosure has been made to address at least one of problems and/or disadvantages described above and to provide at least the advantages described below.

Accordingly, an aspect of the present disclosure is to provide that, by using one electronic device, a user may communicate with another electronic device at a phone number of a user-desired electronic device.

According to an aspect of the present disclosure, a communication method for a first electronic device is provided. The communication method includes receiving from a second electronic device second subscriber information stored in a second subscriber identification module of the second electronic device, receiving second response information generated based on second authentication information from the second electronic device, and transmitting the second response information to a communication network.

According to another aspect of the present disclosure, a machine-readable recording medium having recorded thereon a program for executing a communication method for a first electronic device is provided. The communication method includes receiving, from a second electronic device second subscriber information stored in a second subscriber identification module of the second electronic device; receiving second response information generated based on second authentication information from the second electronic device; and transmitting the second response information to a communication network.

According to another aspect of the present disclosure, a first electronic device is provided, which includes a communication module and a processor configured to receive, from a second electronic device, second subscriber information stored in a second subscriber identification module of the second electronic device using the communication module, to receive second response information generated based on second authentication information from the second electronic device using the communication module, and to transmit the second response information to a communication network using the communication module.

According to another aspect of the present disclosure, a second electronic device is provided, which includes a communication module and a processor configured to transmit subscriber information stored in a subscriber identification module of the second electronic device using the communication module, to receive authentication information from a first electronic device or a communication network using the communication module, to generate response information based on the authentication information, and to transmit the generated response information to the first electronic device.

### BRIEF DESCRIPTION OF THE DRAWINGS

The above and other aspects, features and advantages of a certain embodiment of the present disclosure will be more apparent from the following detailed description, taken in conjunction with the accompanying drawings, in which:

FIG. 1 illustrates a network environment including an electronic device according to an embodiment of the present disclosure;

FIG. 2 is a block diagram of a communication control module of an electronic device according to an embodiment of the present disclosure;

FIG. 3 is a diagram for describing a communication method according to an embodiment of the present disclosure;

FIG. 4 is a flowchart illustrating a communication method according to an embodiment of the present disclosure;

FIGS. 5A-5C and 6A-6C are diagrams for describing a communication method of an electronic device according to an embodiment of the present disclosure;

FIGS. 7A-7B, 8A-8B and 9A-9B are diagrams for describing a communication method according to an embodiment of the present disclosure; and

FIG. 10 is a block diagram of an electronic device according to an embodiment of the present disclosure.

Throughout the drawings, like reference numerals will be understood to refer to like parts, components, and structures.

### DETAILED DESCRIPTION OF EMBODIMENTS OF THE PRESENT INVENTION

Hereinafter, various embodiments of the present disclosure will be described in relation to the accompanying drawings. The various embodiments of the present disclosure may be changed and may have a variety of embodiments, such that particular embodiments have been illustrated in the drawings and a related detailed description thereof will be provided below. However, this is not intended to limit the present disclosure to particular embodiments, and should be understood that all changes, equivalents, or substitutes included in the spirit and technical scope of the present disclosure are included in the scope of the present disclosure. In regard to a description of the drawings, like reference numerals will be used for like components.

Terms “include” or “may include” used in various embodiments described in the present disclosure indicate an existence of disclosed functions, operations, or components, but do not limit an existence of one or more other functions, operations, or components. Terms “include” or “has” used in the present disclosure should be understood that they are intended to indicate an existence of features, numbers, steps, operations, components, items or any combination thereof, disclosed in the specification, but should not be understood that they are intended to previously exclude an existence of one or more other features, numbers, steps, operations, components, or any combination thereof or possibility of adding those things.

The term “or” in various embodiments described in the present disclosure includes any or every combination of listed terms. For example, “A or B” may include either A or B, or both A and B.

Although terms denoting ordinal numbers such as “first”, “second”, and so forth, will be used to describe various components, those components are not limited by the terms. For example, the terms do not limit the order and/or importance of the components. The terms are used for distinguishing one component from another component. For example, a first user device and a second user device are both user devices, and indicate different user devices. Also, a first component may be referred to as a second component, and likewise, a second component may also be referred to as a first component, without departing from the scope of the present disclosure.

When it is said that a component is “connected” or “coupled” with another component, the component may be directly connected with another component, or still another component may exist between the components. On the other hand, when it is said that a component is “directly connected” or “directly coupled” with another component, no component exists between the components.

The term “module” used in various embodiments of the present disclosure may mean a unit including a combination of one or more of hardware, software, and firmware. The “module” may be interchangeably used with a term such as a unit, logic, a logical block, a component, or a circuit. The “module” may be a minimum unit of parts formed integrally as one piece or a part thereof. The “module” may be a minimum unit that performs one or more functions or a part of the minimum unit. The “module” may be mechanically or electronically implemented. For example, the “module” according to various embodiments of the present disclosure may include at least one of (i.e., any one or a partial or whole combination of) an Application-Specific Integrated Circuit (ASIC) chip, Field-Programmable Gate Arrays (FPGAs), and a programmable-logic device that are well-known or to be developed, which perform certain operations.

Terms used in various embodiments of the present disclosure are intended to describe a particular embodiment, rather than to limit the various embodiments of the present disclosure. As used herein, the singular forms are intended to include the plural forms as well, unless the context clearly indicates otherwise.

Unless otherwise defined, all terms (including technical and scientific terms) used herein have the same meaning as commonly understood by one of ordinary skilled in the art to which embodiments belong. It will be further understood that terms, such as those defined in commonly used dictionaries, should be interpreted as having a meaning that is consistent with their meaning in the specification with the context of the relevant art as understood by the artisan at the time of disclosure and will not be interpreted in an idealized or overly formal sense unless expressly so defined herein.

An electronic device according to various embodiments of the present disclosure may be a device having a communication function. For example, the electronic device may include at least one of a smart phone, a tablet Personal Computer (PC), a mobile phone, a video phone, an electronic (e-)book reader, a desktop PC, a laptop PC, a netbook computer, a Personal Digital Assistant (PDA), a Portable Multimedia Player (PMP), a Moving Picture Experts Group Audio Layer 3 (MP3) player, mobile medical equipment, a camera, a wearable device (for example, a Head-Mounted Device (HMD) such as electronic glasses), an electronic cloth, an electronic bracelet, an electronic necklace, an electronic appcessory, an electronic tattoo, and a smart watch.

According to some embodiments, the electronic device may be a smart home appliance having a communication function. The smart home appliance may include, for example, a Television (TV), a Digital Video Disk (DVD) player, audio equipment, a refrigerator, an air conditioner, a vacuum cleaner, an oven, a microwave oven, a laundry machine, an air cleaner, a set-top box, a TV box (for example, HomeSync™ of Samsung, TV™ of Apple, or TV™ of Google), a game console, an electronic dictionary, an electronic key, a camcorder, and an electronic frame.

According to some embodiments, the electronic device may include at least one of various medical equipment (for example, Magnetic Resonance Angiography (MRA), Magnetic Resonance Imaging (MRI), Computed Tomography (CT), an imaging device, or an ultrasonic device), a navigation system, a Global Positioning System (GPS) receiver, an Event Data Recorder (EDR), a Flight Data Recorder (FDR), a vehicle infotainment device, electronic equipment for ships (for example, navigation system and gyro compass for ships), avionics, a security device, a vehicle head unit, an industrial or home robot, an Automatic Teller's Machine (ATM), and a Point of Sales (PoS).

According to some embodiments, the electronic device may include a part of a furniture or building/structure having a communication function, an electronic board, an electronic signature receiving device, a projector, and various measuring instruments (for example, a water, electricity, gas, or electric wave measuring device). The electronic device according to various embodiments of the present disclosure may be one of the above-listed devices or a combination thereof It will be obvious to those of ordinary skilled in the art that the electronic device according to various embodiments of the present disclosure is not limited to the above-listed devices.

Hereinafter, the electronic device according to various embodiments of the present disclosure will be described with reference to the accompanying drawings. The term “user” used in the various embodiments may indicate a person who uses the electronic device or a device (for example, an artificial intelligence electronic device) which uses the electronic device.

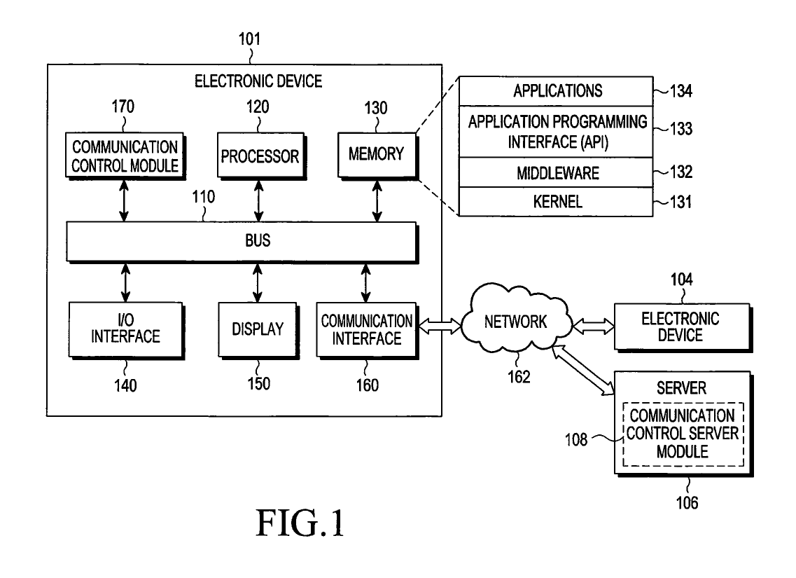

FIG. 1 illustrates a network environment including an electronic device 101 according to an embodiment of the present disclosure. Referring to FIG. 1, the electronic device 101 includes a bus 110, a processor 120, a memory 130, an input/output interface 140, a display 150, a communication interface 160, and a communication control module 170.

The bus 110 is a circuit for connecting the foregoing elements with each other and delivering information (for example, a control message) between the components.

The processor 120 receives a command from the above-described other components (for example, at least one of the memory 130, the input/output interface 140, the display 150, the communication interface 160, and the communication control module 170) through the bus 110, decrypts the received command, and executes an operation or data processing corresponding to the decrypted command.

The memory 130 stores a command or data received from or generated by the processor 120 or other components (for example, at least one of the input/output interface 140, the display 150, the communication interface 160, and the communication control module 170). The memory 130 includes programming modules, for example, a kernel 131, a middleware 132, an Application Programming Interface (API) 133, or at least one of applications 134. These programming modules include software, firmware, hardware, or a combination of at least two of them.

The kernel 131 controls or manages system resources (for example, the bus 110, the processor 120, and the memory 130) used to execute an operation or a function implemented in the other programming modules, for example, the middleware 132, the API 133, and the applications 134. The kernel 131 provides an interface through which the middleware 132, the API 133, or the applications 134 accesses a separate component of the electronic device 101 to control or manage the separate component.

The middleware 132 performs a relay operation such that the API 133 or the applications 134 exchanges data in communication with the kernel 131. The middleware 132 performs a control operation (for example, performs at least one of scheduling, load balancing, and/or the like) with respect to task requests received from the applications 134, by using a method of assigning a priority for using a system resource (for example, at least one of the bus 110, the processor 120, and the memory 130) of the electronic device 101 to, for example, at least one of the applications 134.

The API 133 is an interface through which at least one of the applications 134 controls a function provided by the kernel 133 or the middleware 132, and may include at least one interface or function (for example, a command) for, for example, at least one of a file control, a window control, image processing, and a character control.

According to an embodiment of the present disclosure, at least one of the applications 134 includes at least one of a Short Message Service (SMS)/Multimedia Messaging Service (MMS) application, an e-mail application, a calendar application, an alarm application, a health care application (for example, an application for measuring at least one of the amount of exercise and blood sugar), and an environment information application (for example, an application for providing at least one of atmospheric pressure information, humidity information, and temperature information).

Alternatively, at least one of the applications 134 is an application related to information exchange between the electronic device 101 and an external electronic device (for example, the electronic device 104). The application related to the information exchange includes, for example, a notification relay application for relaying particular information to the external electronic device or a device management application for managing the external electronic device.

For example, the notification relay application includes a function of relaying notification information generated in another application of the electronic device 101 (for example, the SMS/MMS application, the e-mail application, the health care application, or the environment information application) to the external electronic device (for example, the electronic device 104). Alternatively, the notification relay application, for example, receives notification information from the external electronic device and provides the notification information to the user.

The device management application manages (for example, at least one of install, uninstall, and update) a function (for example, at least one of turn-on/turn-off of the external electronic device (or an element thereof) and an adjustment of a brightness (or resolution) of a display) of at least a portion of the external electronic device communicating with the electronic device 101, an application running on the external electronic device, or a service provided in the external electronic device (for example, a call service or a message service).

According to an embodiment of the present disclosure, at least one of the applications 134 includes an application designated according to attributes (for example, a type of the electronic device) of the external electronic device. For example, if the external electronic device is an MP3 player, the applications 134 includes an application related to music playback. If the external electronic device is mobile medical equipment, the applications 134 includes an application related to health care. According to an embodiment of the present disclosure, the application 134 includes at least one of an application designated in the electronic device 101 and an application received from an external electronic device (for example, the server 106 or the electronic device 104).

The input/output interface 140 receives a command or data from a user and delivers the received command or data to at least one of the processor 120, the memory 130, the communication interface 160, and the communication control module 170 through the bus 110. For example, the input/output interface 140 provides data of a user's touch input through a touch screen to the processor 120. The input/output interface 140 outputs a command or data received from at least one of the processor 120, the memory 130, the communication interface 160, and the communication control module 170 through the bus 110 through the input/output device (for example, at least one of a speaker and the display 150). For example, the input/output interface 140 outputs voice data processed by the processor 120 to the user through the speaker.

The display 150 displays a variety of information (for example, at least one of multimedia data and text data) to a user.

The communication interface 160 connects communication between the electronic device 101 and an external electronic device (for example, an electronic device 104 or a server 106). For example, the communication interface 160 is connected to a network 162 through wireless or wired communication to communicate with the external electronic device. The wireless communication may include, for example, at least one of Wireless Fidelity (WiFi), WiFi Direct, Bluetooth (BT), Near Field Communication (NFC), a Global Positioning System (GPS), and cellular communication (for example, Long Term Evolution (LTE), LTE-Advanced (LTE-A), Code Division Multiple Access (CDMA), Wideband CDMA (WCDMA), a Universal Mobile Telecommunication System (UMTS), Wireless Broadband (WiBro), or Global System for Mobile Communications (GSM)). The wired communication may include, for example, at least one of a Universal Serial Bus (USB), a High Definition Multimedia Interface (HDMI), a Recommended Standard (RS)-232, and a Plain Old Telephone Service (POTS).

According to an embodiment of the present disclosure, the network 162 is a telecommunications network that may include at least one of a computer network, Internet, Internet of things, and a telephone network. According to an embodiment of the present disclosure, a protocol (for example, a transport layer protocol, a data link layer protocol, or a physical layer protocol) for communication between the electronic device 101 and the external electronic device may be supported in at least one of the applications 134, the API 133, the middleware 132, the kernel 131, and the communication interface 160.

According to an embodiment of the present disclosure, the communication control module 170 supports driving of the electronic device 101 by performing at least one of operations (or functions) implemented in the electronic device 101. For example, the server 106 includes a communication control server module 108 capable of supporting the communication control module 170 implemented in the electronic device 101. The communication control server module 108 includes at least one element of the communication control module 170 to perform (for example, to perform in place of the communication control module 170) at least one of operations performed by the communication control module 170.

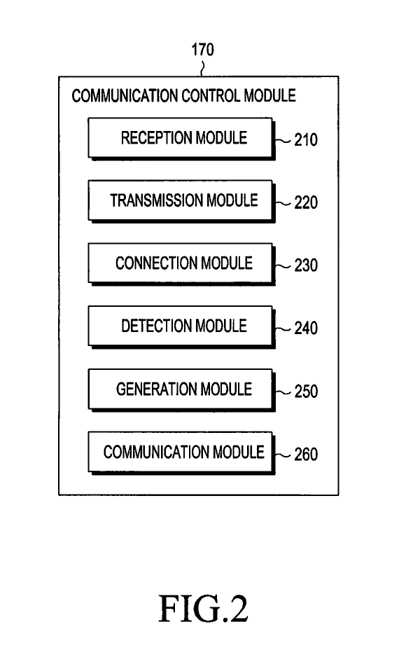

The communication control module 170 processes at least a part of information obtained from other elements (for example, at least one of the processor 120, the memory 130, the input/output interface 140, and the communication interface 160), and uses the processed information in various ways. For example, the communication control module 170 may control at least some functions of the electronic device 101 by using the processor 120 or operate independently of the processor 120, such that the electronic device 101 cooperates with another electronic device (for example, the electronic device 104 or the server 106). The communication control module 170 may be integrated into the processor 120. According to an embodiment of the present disclosure, at least one element of the communication control module 170 may be included in the server 106 (for example, the communication control server module 108), and may be supported with at least one operation implemented in the communication control module 170 from the server 106. With reference to FIG. 2, additional information regarding the communication control module 170 will be provided.

FIG. 2 is a block diagram of the communication control module 170 of an electronic device (for example, the electronic device 101 of FIG. 1) according to an embodiment of the present disclosure. Referring to FIG. 2, the communication control module 170 includes a reception module 210, a transmission module 220, a connection module 230, a detection module 240, a generation module 250, and a communication module 260. Hereinafter, the electronic device will be referred to as a first electronic device and another electronic device will be referred to as a second electronic device.

The reception module 210 according to an embodiment of the present disclosure receives second subscriber information (for example, Subscriber Identification Module (SIM) information) stored in a second SIM of the second electronic device from the second electronic device. The reception module 210 receives second response information generated by reception of second authentication information from the second electronic device. The reception module 210 receives a notification for transmission of the second subscriber information from the second electronic device. The reception module 210 receives the second authentication information for authentication of a second subscriber, the second SIM, or the second subscriber information from the communication network (for example, the network 162 of FIG. 1). The second authentication information may include a first value, and the second response information may include a second value generated based on the first value. The reception module 210 receives first authentication information for authentication of a first subscriber, a first SIM, or the first subscriber information from the communication network.

The transmission module 220 according to an embodiment of the present disclosure transmits the second response information to the communication network. The transmission module 220 requests the second electronic device to provide the second subscriber information. The communication network may be a telephone network. The transmission module 220 sends a message requesting the second subscriber information to the second electronic device. The transmission module 220 transmits at least a part of the second subscriber information to the communication network. The at least a part of the second subscriber information includes at least one of a phone number of the second subscriber, a subscriber identification number, and an International Mobile Station Identity (IMSI). The transmission module 220 transmits the second authentication information to the second electronic device. The transmission module 220 transmits the second authentication information to the second electronic device. The transmission module 220 transmits at least a part of the first subscriber information stored in the first SIM of the first electronic device to the communication network. The transmission module 220 transmits first response information generated based on the first authentication information received from the communication network to the communication network.

The connection module 230 according to an embodiment of the present disclosure establishes communication connection between the first electronic device and the second electronic device. The communication connection may be wireless communication connection or wired communication connection, and may include BT, WiFi, WiFi Direct, Bluetooth Low Energy (BLE), NFC, Zigbee optical communication, and/or the like.

The detection module 240 according to an embodiment of the present disclosure detects an event that requires a request for the second subscriber information. The event may occur based on at least one of a user input, a request of the second electronic device, a distance between the first electronic device and the second electronic device, a communication connection with the second electronic device, and environment setting of the first electronic device.

The generation module 250 according to an embodiment of the present disclosure generates the first response information based on the first authentication information.

The communication module 260 according to an embodiment of the present disclosure communicates with the communication network by using at least one of a phone number of a first subscriber, a subscriber identification number, and an IMSI that correspond to the first subscriber information. The communication module 260 also communicates with the communication network by using at least one of a phone number of the second subscriber, a subscriber identification number, and an IMSI that correspond to the second subscriber information.

In an embodiment of the present disclosure, the connection module 230 establishes a communication connection between the first electronic device and the second electronic device. The detection module 240 detects an event that requires a request for the second subscriber information. Upon detecting the event, the transmission module 220 sends a request for the second subscriber information to the second electronic device. The reception module 210 receives the second subscriber information stored in the second SIM of the second electronic device, which is transmitted from the second electronic device in response to the request. The transmission module 220 transmits at least a part of the second subscriber information to the communication network. The transmission module 220 sends a request for registration or authentication of the second subscriber, the second SIM, or the second subscriber information to the communication network, together with or separate from the at least a part of the second subscriber information. The reception module 210 receives the second authentication information transmitted by the communication network in response to reception of the at least a part of the second subscriber information. The transmission module 220 transmits the second authentication information to the second electronic device in response to reception of the second authentication information. The transmission module 220 sends a request for the second response information to the second electronic device, together with or separate from the second authentication information. The reception module 210 receives second response information transmitted by the second electronic device in response to reception of the second authentication information. The transmission module 220 transmits the received second response information to the communication network.

In an embodiment of the present disclosure, instead of the transmission module 220 requesting the second electronic device to provide the second subscriber information, the reception module 210 receives a notification for transmission of the second subscriber information from the second electronic device. The second subscriber information may be transmitted together with or separate from the notification. The second electronic device detects an event that requires the notification for transmission of the second subscriber information, and the notification for transmission of the second subscriber information is sent upon detecting the event. The event may occur based on at least one of the user input, the request of the second electronic device, a distance between the first electronic device and the second electronic device, a communication connection with the first electronic device, and environment setting of the second electronic device.

In an embodiment of the present disclosure, instead of the transmission module 220 transmitting the second authentication information to the second electronic device, the reception module 210 receives the second authentication information for authentication of the second subscriber from the communication network. Upon receiving the second authentication information, the transmission module 220 transmits the second authentication information to the second electronic device.

In an embodiment of the present disclosure, together with or separated from operations for a registration or authentication of the second subscriber, the second SIM, or the second subscriber information, the first electronic device performs operations for a registration or authentication of the first subscriber, the first SIM, or the first subscriber information. The transmission module 220 transmits at least a part of the first subscriber information to the communication network. The transmission module 220 sends a request for a registration or authentication of the first subscriber, the first SIM, or the first subscriber information to the communication network, together with or separate from the at least a part of the first subscriber information. The reception module 210 receives the first authentication information transmitted by the communication network in response to reception of the at least a part of the first subscriber information. The generation module 250 generates the first response information based on the first authentication information. The transmission module 220 transmits the generated first response information to the communication network.

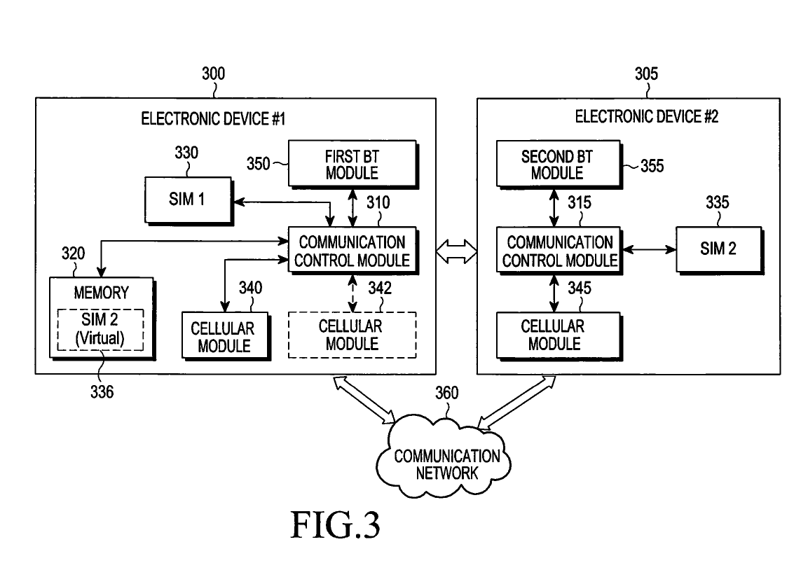

FIG. 3 is a diagram for describing a communication method according to an embodiment of the present disclosure.

Referring to FIG. 3, a first electronic device 300 includes a first communication control module 310, a memory 320, a first Subscriber Identification Module (SIM 1) 330, a first cellular module 340, and a first Bluetooth (BT) module 350. The first electronic device 300 may further include a third cellular module 342. A second electronic device 305 includes a second communication control module 315, a second Subscriber Identification Module (SIM 2) 335, a second cellular module 345, and a second BT module 355.

The first SIM 330 includes first subscriber information (or first SIM information) used to identify and authenticate the first user (i.e., a first subscriber) of the first electronic device 300 on the communication network 360. The first subscriber information includes at least one of a unique identifier (for example, an Integrated Circuit Card Identifier (ICCID)) of the first SIM 330, a unique identifier (for example, an IMSI) of the first subscriber, security authentication and/or encryption information, temporary information related to the communication network 360, a list of services the user has accessed, a Personal Identification Number (PIN), and a Personal Unblocking Code (PUK) for unlocking the PIN. The security authentication and/or encryption information includes at least one of a user-specific secret key K, certain message authentication functions f1 and f2, certain key generating functions f3, f4, and f5, a sequence number SQN, a random value or random challenge value RAND, an authentication token AUTN, an authentication response value RES or SRES, a cipher key CK or K_{C}, and an integrity key IK.

In an embodiment of the present disclosure, the communication network 360 includes a Serving Network (SN) including at least one of a base station, a radio network controller, and a Visitor's Location Register (VLR)/Serving GPRS Support Node (SGSN) and a Home Environment (HE) including at least one of a Home Location Register (HLR)/Authentication Center (AuC).

The second SIM 335 includes second subscriber information (or second SIM information) used to identify and authenticate a second user (i.e., a second subscriber) of the second electronic device 305 on the communication network 360. The second subscriber information includes at least one of a unique identifier (for example, an ICCID) of the second SIM 335, a unique identifier (for example, an IMSI) of the second user, security authentication and/or encryption information, temporary information related to the communication network 360, a list of services the second user has accessed, a PIN, and a PUK for unlocking the PIN. The security authentication and/or encryption information includes at least one of a user-specific secret key K, certain message authentication functions f1 and f2, and certain key generating functions f3, f4, and f5.

Each of the first cellular module 340 and the second cellular module 345 provides at least one of voice communication, video communication, a messaging service, and an Internet service through the communication network 360 (for example, LTE, LTE-A, CDMA, WCDMA, UMTS, WiBro, GSM, and/or the like).

The first cellular module 340 identifies, registers, or authenticates the first user with respect to the communication network 360 by using the first SIM 330. The first cellular module 340 may be controlled by a Communication Processor (CP) of the first electronic device 300, may include the CP, may be integrated into the CP, or may function as the CP. The first cellular module 340 may be referred to as a modem or a CP.

The second cellular module 345 identifies, registers, or authenticates the second user with respect to the communication network 360 by using the second SIM 335. The second cellular module 345 may be controlled by a CP of the second electronic device 305, may include the CP, may be integrated into the CP, or may function as the CP. The second cellular module 345 may be referred to as a modem or a CP.

The first BT module 350 is communication-connected with the second BT module 355, and transmits or receives data or a signal including at least one of voice, video, texts, and/or the like, through communication connection. The first BT module 350 may be controlled by an Application Processor (AP) of the first electronic device 300 or may be integrated into the AP.

The second BT module 355 is communication-connected with the first BT module 350, and transmits or receives data or a signal including at least one of voice, video, texts, and/or the like, through communication connection. The second BT module 355 may be controlled by an AP of the second electronic device 305 or may be integrated into the AP.

Each of the first communication control module 310 and the second communication control module 315 may be controlled by an AP of a corresponding electronic device or may be integrated into the AP. Each of the communication control modules 310 and 315 performs operations for registration or authentication of a corresponding user, a corresponding SIM 330 or 335, or corresponding subscriber information.

The first communication control module 310 transmits at least a part of the first subscriber information stored in the first SIM 330 and/or a request for registration or authentication of the first subscriber to the communication network 360 through the first cellular module 340. The first communication control module 310 receives the first authentication information, transmitted in response to reception of the at least a part of the first subscriber information, through the first cellular module 340. The first communication control module 310 generates first response information based on the first authentication information. The first communication control module 310 transmits the first response information to the communication network 360 through the first cellular module 340. The communication network 360 compares the response information received from the first electronic device 300 with the response information generated by the communication network 360. If the response information coincide with each other, the communication network 360 determines that authentication of the first user is successful. If the authentication of the first user is successful, the first electronic device 300 communicates with the communication network 360 through the first cellular module 340 by using a phone number, subscriber identification information, or an IMSI of the first user. If the response information do not coincide with each other, the communication network 360 determines that authentication of the first user has failed. If the authentication of the first user fails, the communication network 360 rejects a communication request of the first electronic device 300 or transmits new first authentication information to the first electronic device 300.

The second communication control module 315 transmits at least a part of second subscriber information stored in the second SIM 335 and/or a request for registration or authentication of the second subscriber to the communication network 360 through the second cellular module 315. The second communication control module 315 receives the second authentication information, transmitted in response to reception of the at least a part of the second subscriber information, through the second cellular module 345. The second communication control module 315 generates second response information based on the second authentication information. The second communication control module 315 transmits the second response information to the communication network 360 through the second cellular module 345. The communication network 360 compares the response information received from the second electronic device 305 with the response information generated by the communication network 360. If the response information coincide with each other, the communication network 360 determines that authentication of the second user is successful. If the authentication of the second user is successful, the second electronic device 305 communicates with the communication network 360 through the second cellular module 345 by using a phone number, subscriber identification information, or an IMSI of the second user. If the response information do not coincide with each other, the communication network 360 determines that authentication of the second user has failed. If the authentication of the second user fails, the communication network 360 rejects a communication request of the second electronic device 305 or transmits new second authentication information to the second electronic device 305.

In an embodiment of the present disclosure, the first BT module 350 and the second BT module 355 establish a peer-to-peer (or one-to-one) communication connection. Each of the BT modules 350 and 355 is a module enabling communication with a BT device complying with the Bluetooth standards, such that a certain interface (for example, a Host Control Interface (HCI)) is previously defined between the BT modules 350 and 355, and a control command, a response, and data are transmitted and received through message packets using the interface.

For example, the first BT module 350 transmits a signal for synchronization (i.e., a sync signal) and a message for requesting registration of a unique ID (i.e., a registration request message). The second BT module 355 is synchronized with the first BT module 350 by using the sync signal and sends a response message including a unique ID of the second BT module 355 to the first BT module 350 in response to the registration request message. The first BT module 350 sends a message for requesting communication connection (i.e., a connection request message). The second BT module 355 sends a response message indicating an acceptance or rejection to the first BT module 350 in response to the registration request message. By exchanging the request messages and the response messages, the first BT module 350 and the second BT module 355 are communication-connected with each other.

After a communication connection is established between the first BT module 350 and the second BT module 355, the first communication control module 310 detects an event that requires a request for the second subscriber information. The event may occur based on at least one of a user input, a request or a notification of the second electronic device 305, a distance between the first electronic device 300 and the second electronic device 305, a communication connection between the first electronic device 300 and the second electronic device 305 (or the first BT module 350 and the second BT module 355), and environment setting of the first electronic device 300. For example, the first communication control module 310 detects a change in a distance between the first electronic device 300 and the second electronic device 305 through the first BT module 350. The first communication control module 310 detects the distance change through a change in the strength of a transmission signal of the second BT module 355, which is received through the first BT module 350. The first communication control module 310 determines that the event that requires the request for the second subscriber information occurs, if the strength of the signal received from the second BT module 355 is equal to or greater than a predetermined threshold value.

Upon detecting the event, the first communication control module 310 sends a request for the second subscriber information to the second electronic device 305 through the first BT module 350. The second communication control module 315 transmits the second subscriber information stored in the second SIM 335 or a portion thereof to the first electronic device 300 through the second BT module 355 in response to the request. The second subscriber information transmitted by the second communication control module 315 may include at least one of a unique identifier (for example, an ICCID) of the second SIM 335, a unique identifier (for example, an IMSI) of the second subscriber, security authentication and/or encryption information (for example, a cipher key, an integrity key, and/or the like), temporary information related to the communication network 360, a list of services the second user has accessed, a PIN, a PUK for unlocking the PIN, and/or the like. The first communication control module 310 stores the second subscriber information received from the second electronic device 305 in the memory 320 of the first electronic device 300, thus generating a virtual second SIM 336. The first communication control module 310 transmits at least a part (for example, an IMSI) of the second subscriber information stored in the memory 320 to the communication network 360 through the first cellular module 340. The first communication control module 310 sends a request for registration or authentication of the second user, the second SIM 335, or the second subscriber information to the communication network 360 through the first cellular module 340, together with or separated from the at least a part of the second subscriber information.

The communication network 360 transmits second authentication information (for example, at least one of a RAND, AUTN, and/or the like) to the first electronic device 300 in response to reception of the at least a part of the second subscriber information. The first communication control module 310 the second authentication information to the second electronic device 305 through the first BT module 350 in response to reception of the second authentication information. The first communication control module 310 transmits a request for second response information to the second electronic device 305 through the first BT module 350, together with or separate from the second authentication information. The second communication control module 315 generates the second response information (for example, at least one of an RES, an SRES, a CK, an IK, a K_{C}, and/or the like) based on the second authentication information. The second communication control module 315 transmits the second response information or a portion thereof (for example, at least one of an RES, an SRES, a CK, an IK, a K_{C}, and/or the like) to the first electronic device 300 through the second BT module 355. The first communication control module 315 stores the second response information received from the second electronic device 305 in the memory 320 of the first electronic device 300. The first communication control module 310 transmits the second response information stored in the memory 320 or a portion thereof (for example, at least one of an RES, an SRES, and/or the like) to the communication network 360 through the first cellular module 340. The communication network 360 compares the second response information received from the first electronic device 300 with the response information generated by the communication network 360, and if the response information coincide with each other, the communication network 360 determines that authentication of the second user is successful. If authentication of the second user is successful, the first communication control module 310 communicates with the communication network 360 through the first cellular module 340 by using a phone number, a subscriber identification number, or an IMSI of the second user. If the response information do not coincide with each other, the communication network 360 determines that authentication of the second user has failed. If authentication of the second user fails, the communication network 360 rejects a communication request of the first electronic device 300 or transmits new second authentication information to the first electronic device 300.

In an embodiment of the present disclosure, in response to a request for the second subscriber information, the second communication control module 315 turns off the second cellular module 345 or controls the second cellular module 345 to operate in a sleep state or mode. In the sleep mode, all functions or some of them (for example, at least one of a data or signal transmission function, a data or signal reception function, and/or the like) may be stopped. The second cellular module 345 having entered the sleep mode returns to a normal mode in which all the functions may be performed, in response to a control signal (for example, a wake-up signal) of the second communication control module 315. In order to turn off the second cellular module 345, the second communication control module 315 performs a typical modem rebooting process by which the second electronic device 305 is restarted (or initialized), whereby the second cellular module 345 is turned off and the second BT module 355 is turned on.

In an embodiment of the present disclosure, upon receiving the second subscriber information, the first communication control module 310 may control the first cellular module 340 to operate in a dual SIM mode by supporting the first SIM 330 and the virtual second SIM 336. The first communication control module 310 executes a process of registering and/or authenticating the first user and a process of registering and/or authenticating the second user to support the dual SIM mode.

The first electronic device 300 includes one cellular module 340, and in this case, the first electronic device 300 operates in a dual SIM single standby mode. In the dual SIM single standby mode, the first electronic device 300 operates in a mode in which only reception of data or a signal is possible (i.e., a reception-only mode that does not permit transmission of data or a signal) by using the virtual second SIM 336. In the dual SIM single standby mode, by using network connection scheduling, call forwarding, and/or the like, the first electronic device 300 supports transmission and reception of data or a signal to/from the communication network 360 using the first SIM 330 and transmission and reception of data or a signal to/from the communication network 360 using the virtual second'SIM 336.

In an embodiment of the present disclosure, the first electronic device 300 includes two cellular modules (i.e., the first cellular module 340 and the third cellular module 342), and in this case, the first electronic device 300 operates in a dual SIM dual standby mode. In the dual SIM dual standby mode, the first electronic device 300 transmits and receives data or a signal to/from the communication network 360 by using the first SIM 330 and the first cellular module 340 and transmits and receives data or a signal to/from the communication network 360 by using the virtual second SIM 336 and the third cellular module 342.

In an embodiment of the present disclosure, the first electronic device 300 may switch the first SIM 330 and the virtual second SIM 336 to use them, and in this case, one of the first SIM 330 and the virtual second SIM 336 may be activated and the other may be deactivated. The first electronic device 300 may receive a call, which is received at a phone number of the deactivated SIM, at a phone number of the activated SIM, by using call forwarding. In this case, the activated state means a state in which transmission and reception of data or a signal are possible, and the deactivated state means a state in which only reception of data or a signal is possible or transmission and reception of data or a signal are both impossible.

In an embodiment of the present disclosure, besides the one-to-one communication connection using the BT modules 350 and 355 (for example, Bluetooth Low Energy (BLE) modules), a one-to-one communication connection using WiFi modules or NFC modules may be established, and the first electronic device 300 and the second electronic device 305 may exchange authentication information and response information through the WiFi modules or the NFC modules.

In an embodiment of the present disclosure, authentication information transmitted by the communication network 360 (for example, a SN/VLR) includes an RAND and an AUTN. The AUTN includes a SQN, an Authentication Management Field (AMF), and a Message Authentication Code (MAC). The respective communication control modules 310 and 315 determine whether the AUTN may be permitted, and if the AUTN is permitted, they transmit response information RES to the communication network 360. The communication network 360 (for example, the SN/VLR) compares its generated response information XRES with the received RES. If the XRES and the RES coincide with each other, the communication network 360 determines that authentication of a subscriber is successful. If the XRES and the RES do not coincide with each other, the communication network 360 determines that authentication of the subscriber has failed.

In an embodiment of the present disclosure, the authentication information transmitted by the communication network 360 (for example, the SN/VLR) includes an RAND. The respective communication control modules 310 and 315 generate an SRES by substituting the RAND and the user-specific cipher key K to a preset function A3. The respective communication control modules 310 and 315 transmit the response information SRES to the communication network 360. The communication network 360 (for example, the SN/VLR) compares its generated SRES with the received SRES, and if they coincide with each other, the communication network 360 determines that authentication of the subscriber is successful. If they do not coincide with each other, the communication network 360 determines that authentication of the subscriber has failed.

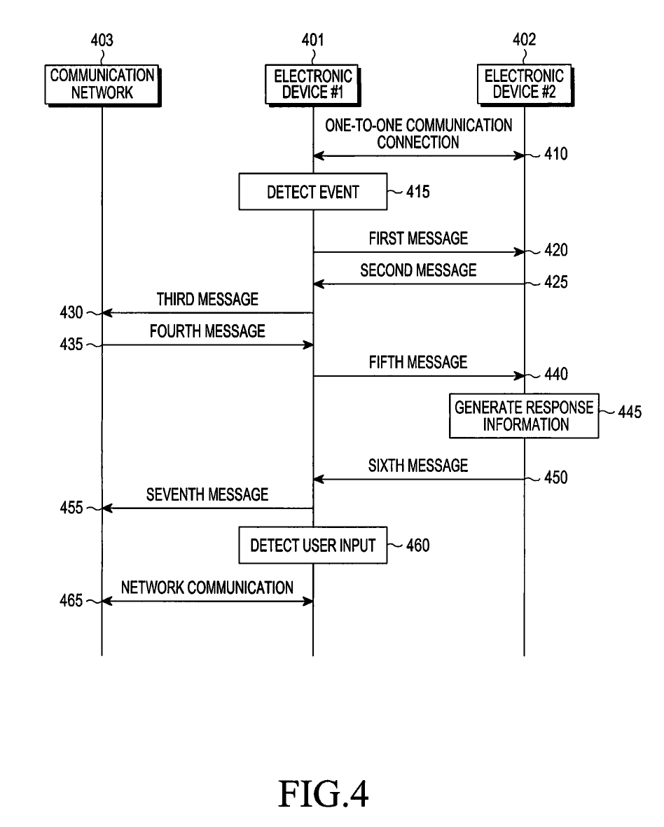

FIG. 4 is a flowchart illustrating a communication method according to an embodiment of the present disclosure. In the current example, a user may have a first electronic device 401 and a second electronic device 402, and the first electronic device 401 includes a first SIM and the second electronic device 402 includes a second SIM. The user may be registered in a communication network 403 as a first subscriber of the first SIM and as a second subscriber of the second SIM.

In step 410, the first electronic device 401 and the second electronic device 402 establish a short-range one-to-one communication connection. The short-range one-to-one communication connection is a connection capable of directly transmitting data or a signal between the first electronic device 401 and the second electronic device 402 without an intermediate device that relays the data or the signal. The short-range one-to-one communication connection may be a BT connection, a WiFi connection, a NFC connection, and/or the like. For example, the first electronic device 401 and the second electronic device 402 may establish a BT connection.

In step 415, the first electronic device 401 detects an event that requires a request for second subscriber information stored in the second SIM of the second electronic device 402. In an embodiment of the present disclosure, instead of having the first electronic device 401 detecting the event that requires the request for the second subscriber information, the second electronic device 402 detects an event that requires delivery of the second subscriber information. In an embodiment of the present disclosure, the second electronic device 402 detects an event that requires a notification for transmitting second subscriber information stored in the second SIM of the second electronic device 402.

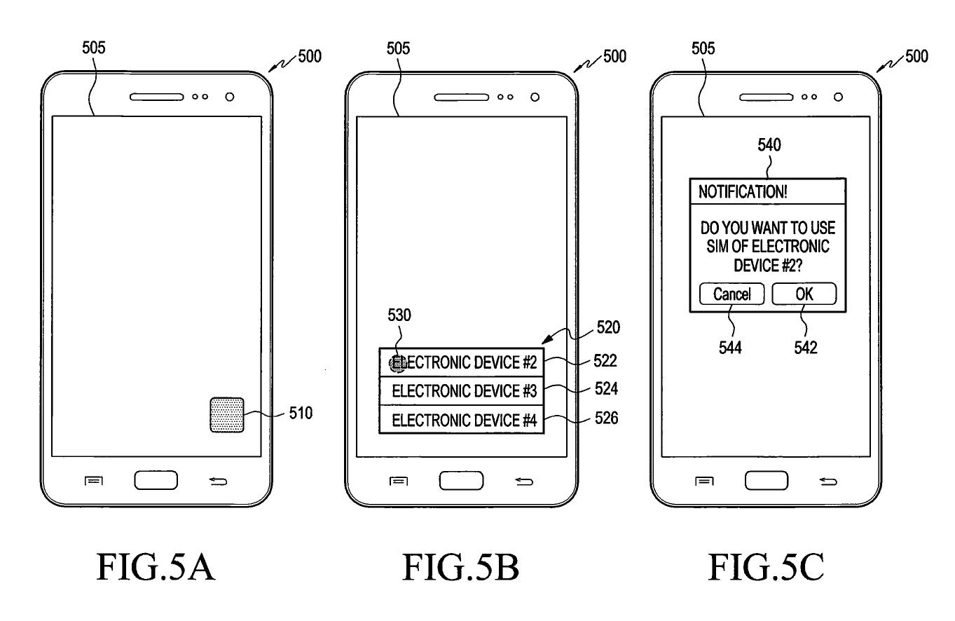

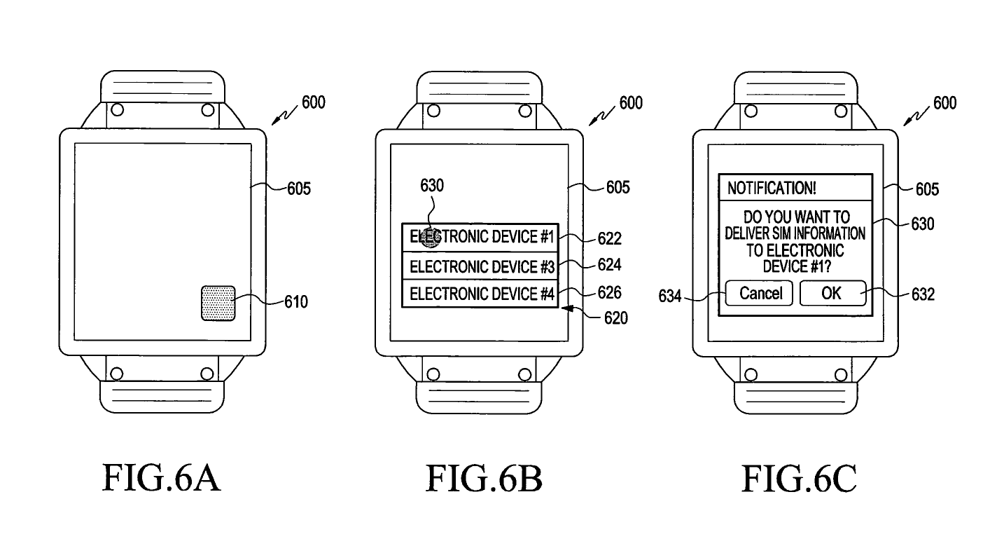

FIGS. 5A-5C and 6A-6C are diagrams for describing a communication method of an electronic device according to an embodiment of the present disclosure.

Referring to FIG. 5A, a first electronic device 500 displays an item (or a graphic element) 510 for requesting second subscriber information on a display 505. In this example, the first electronic device 500 is a smart phone. The item 510 includes one or more of a text, a symbol, an image, and an icon.

Upon detecting a user's selection of the item 510, the first electronic device 500 displays a list 520 of peripheral devices on the display 505 by using information received from the peripheral devices as illustrated in FIG. 5B. The list 520 shows identifiers 522, 524, and 526 of second, third, and fourth electronic devices, respectively. For example, the user may use a SIM of an electronic device by selecting an identifier of the electronic device.

For example, if the user selects the identifier 522 of the second electronic device as indicated by reference numeral 530, the first electronic device 500 displays a notification message 540 to the user through the display 505 as illustrated in FIG. 5C.

The notification message 540 shows a guide phrase “Use SIM of Second Electronic Device?”, and includes an OK button 542 for confirming a subscriber information request and a Cancel button 544 for canceling the subscriber information request. Upon detecting a user's selection of the OK button 542, the first electronic device 500 sends a request for second subscriber information stored in the second SIM of the second electronic device to the second electronic device. If the user selects the Cancel button 544, the first electronic device 500 cancels the subscriber information request.

Referring to FIG. 6A, a second electronic device 600 displays an item (or a graphic element) 610 for delivering second subscriber information on a display 605. In this example, the second electronic device 600 is a smart watch.

Upon detecting a user's selection of the item 610, the second electronic device 600 displays a list 620 of peripheral devices on a display 605 by using information received from the peripheral devices as illustrated in FIG. 6B. The list 620 shows identifiers 622, 624, and 626 of first, third, and fourth electronic devices, respectively. For example, the user may deliver information of a SIM to an electronic device by selecting an identifier of the electronic device.

For example, upon detecting a user's selection at 630 of the identifier 622 of the first electronic device, the first electronic device 600 displays a notification message 630 to the user through the display 605 as illustrated in FIG. 6C.

The notification message 630 shows a guide phrase “Deliver SIM Information to First Electronic Device?” and includes an OK button 632 for confirming subscriber information delivery and a Cancel button 634 for canceling subscriber information delivery. Upon detecting a user's selection of the OK button 632, the second electronic device 600 transmits the second subscriber information stored in the second SIM of the second electronic device 600 to the first electronic device. If the user selects the Cancel button 634, the second electronic device 600 cancels delivery of the second subscriber information.

In step 420, upon detecting the event, the first electronic device 401 sends a request for the second subscriber information to the second electronic device 402 through a one-to-one communication connection. For example, the first electronic device 401 sends a first message including at least one of an indicator requesting the second subscriber information and a text to the second electronic device 402 through a BT connection. In an embodiment of the present disclosure, the first electronic device 401 receives a notification for transmitting the second subscriber information from the second electronic device 402.

In step 425, the second electronic device 402 transmits the second subscriber information to the first electronic device 401 in response to the request. In an embodiment of the present disclosure, upon detecting the event that requires delivery of the second subscriber information, the second electronic device 402 transmits the second subscriber information to the first electronic device 401 without the request from the first electronic device 401. In an embodiment of the present disclosure, the second electronic device 402 may transmit the second subscriber information to the first electronic device 401 after transmitting the notification for transmitting the second subscriber information to the first electronic device 401. For example, the second electronic device 402 sends a second message including the second subscriber information to the first electronic device 401 through the BT connection. The second subscriber information includes at least one of a unique identifier (for example, an ICCID) of the second SIM, a unique identifier (for example, an IMSI) of the second subscriber, security authentication and/or encryption information, temporary information associated with the communication network 403, a list of services the second subscriber has accessed, a PIN, and a PUK for unlocking the PIN. The first electronic device 401 stores the second subscriber information received from the second electronic device 402 in the memory of the first electronic device 401 to generate a virtual second SIM.

In step 430, the first electronic device 401 transmits at least a part of the second subscriber information stored in the memory to the communication network 403 through a first cellular module. For example, the first electronic device 401 sends a third message including an IMSI of the second subscriber information to the communication network 403 through the first cellular module. The third message includes at least one of an indicator requesting registration or authentication of the second subscriber and a text.

In step 435, the communication network 403 sends a fourth message including second authentication information (for example, at least one of an RAND, an AUTN, and/or the like) to the first electronic device 401 in response to reception of the at least a part of the second subscriber information. For example, the communication network 403 sends the fourth message including the RAND and the AUTN to the first electronic device 401. As another example, the communication network 403 sends the fourth message including the RAND to the first electronic device 401.

In step 440, the first electronic device 401 transmits at least a part of the second authentication information to the second electronic device 402 in response to reception of the second authentication information through the one-to-one communication connection. For example, the first electronic device 401 may send a fifth message including the RAND and the AUTN or including the RAND to the second electronic device 402 through the BT connection.

In step 445, the second electronic device 402 generates second response information based on the second authentication information. For example, the second electronic device 402 generates an RES, a CK, and an IK. As another example, the second electronic device 402 generates an SRES and a K_{C}.

In step 450, the second electronic device 402 transmits the second response information or a portion thereof to the first electronic device 401 through the one-to-one communication connection. For example, the second electronic device 402 sends a sixth message including an RES to the first electronic device 401 through the BT connection. As another example, the second electronic device 402 sends the sixth message including an SRES to the first electronic device 401 through the BT connection.

In step 455, the first electronic device 401 transmits the second response information or a portion thereof to the communication network 403 through the first cellular module. For example, the first electronic device 401 sends a seventh message including an RES to the communication network 403 through the first cellular module. As another example, the first electronic device 401 sends the sixth message including the SRES to the communication network 403 through the first cellular module. The communication network 403 compares the second response information received from the first electronic device 401 (for example, the RES or the SRES) with the response information generated by the communication network 403, and if they coincide with each other, the communication network 403 determines that authentication of the second subscriber is successful. If the authentication of the second subscriber is successful, the first electronic device 401 communicates with the communication network 403 through the first cellular module by using a phone number, a subscriber identification number, or an IMSI of the second subscriber. If they do not coincide with each other, the communication network 403 determines that authentication of the second subscriber has failed. If authentication of the second subscriber fails, the communication network 403 rejects a communication request using the virtual second SIM of the first electronic device 401 or transmits new second authentication information to the first electronic device 401.

In step 460, the first electronic device 401 detects a user's input that needs communication using the virtual second SIM. The first electronic device 401 displays a screen portion for designating one of the first SIM and the virtual second SIM on a display. The screen portion may be a text (for example, a selectable text) or an image (for example, an icon) included on an application screen or may be displayed as a screen that is separate from the application screen. If the user executes a particular application, the application screen may be a screen (for example, a window) displayed on the display of the first electronic device. For example, the screen portion may be a text (for example, a selectable text) or an image (for example, an icon) included on the application screen.

The application may be an application that needs communication with the communication network 403 or with a third electronic device through the communication network 403, and may be, for example, a phone application, a text application, a voice recognition application, a schedule management application, a document generation application, a music application, an Internet application, a map application, a camera application, an e-mail application, an image editing application, a search application, a file search application, a video application, a game application, a Social Networking Service (SNS), a message application, a handwriting input application, a character input application (or a keyboard/keypad application), a cursor application, a streaming application, a mirroring application, and/or the like.

In an embodiment of the present disclosure, a message or a notification window for designating one of the first SIM and the virtual second SIM is displayed on the application screen. The screen portion includes a first item (for example, a first button) for designating the first SIM and a second item (for example, a second button) for designating the virtual second SIM. The screen portion includes a first identifier (for example, a mobile, a first SIM, a first phone number, and/or the like) corresponding to the first SIM and a second identifier (for example, a watch, a second SIM, a second phone number, and/or the like) corresponding to the virtual second SIM. Each of the first identifier and the second identifier is displayed as contact information, a phone number, a name of a device or module (for example, a first or second SIM), a set text, or a set icon.

In step 465, the first electronic device 401 communicates with the communication network 403 (or the third electronic device through the communication network 403) by using the phone number, the subscriber identification number, or the IMSI of the second subscriber in response to a communication request using the virtual second SIM. The first electronic device 401 sends a message or a signal for at least one of a call service, a message service, and a multimedia service to the communication network 403.

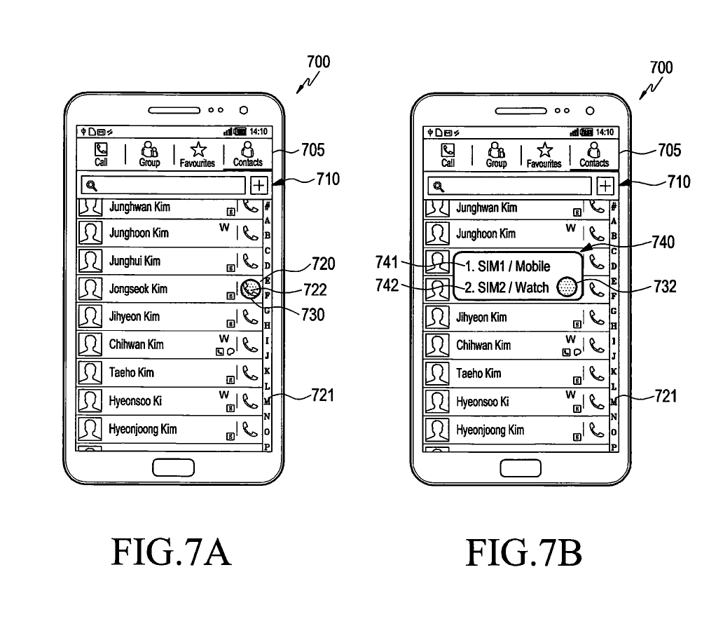

FIGS. 7A-7B, 8A-8B, and 9A-9B are diagrams for describing a communication method according to an embodiment of the present disclosure.

Referring to FIG. 7A, a contact information screen 710 of a phone application is displayed on a display 705 of a first electronic device 700, and the contact information screen 710 includes a plurality of contacts that may include at least one contact 720 registered by the first electronic device 700 and at least one contact 721 registered by a second electronic device. For example, the first electronic device 700 receives contact information stored in the memory of the second electronic device, together with or separated from the second subscriber information, from the second electronic device, and stores the received contact information in the memory of the first electronic device 700. The contact 721 registered by the second electronic device may be highlighted so as to be distinguished from the contact 720 registered by the first electronic device 700. The highlighting may include visual highlighting, audible highlighting, and tactile highlighting. For example, visual highlighting is implemented by additionally displaying an icon, an image, a text, and/or the like, or making a color, a shape, a transparency, or a position of the contact 721 registered by the second electronic device different from that of the contact 720 registered by the first electronic device 700. Audible highlighting is implemented by outputting a voice (for example, guide voice) or sound (for example, alert sound) if the user selects the contact 721 registered by the second electronic device. Tactile highlighting is implemented by applying a vibration if the user selects the contact 721 registered by the second electronic device. In this example, the contact 721 registered by the second electronic device is highlighted by additionally displaying an icon W.

According to an embodiment of the present disclosure, if the one-to-one communication connection between the first electronic device 700 and a second electronic device is released, the contact 721 registered by the second electronic device is deactivated or hidden.

A first screen portion 722 for receiving an input for communication may be the entire contact screen 710 or a portion thereof. For example, the first screen portion 722 is a call icon.

Upon detecting a selection 730 of arbitrary contact information (for example, the first screen portion 722 of the contact 720 registered by the first electronic device) on the contact information screen 710 illustrated in FIG. 7A, the first electronic device 700 displays a second screen portion 740 for designating at least one of the first SIM and the virtual second SIM as illustrated in FIG. 7B. The second screen portion 740 includes a first identifier (for example, SIM1/Mobile) corresponding to the first SIM and a second identifier (for example, SIM2/Watch) corresponding to the virtual second SIM. Each of the first and second identifiers may be displayed as contact information, a phone number, a name of a device or module, a set text, or a set icon. The second screen portion 740 includes a selectable first item 741 including the first identifier and a selectable second item 742 including the second identifier. The user may designate a desired SIM by selecting one of the first item 741 and the second item 742. For example, if a user's selection of the first item 741 is detected, the first electronic device 700 calls or sends a message to a third electronic device by using contact information (for example, a phone number) of the first electronic device 700 (or the first SIM) as a caller. As another example, upon detecting a selection 732 of the second item 742 by the user, the first electronic device 700 calls or sends a message to the third electronic device by using contact information (for example, a phone number) of the second electronic device (or the second SIM) as a caller.

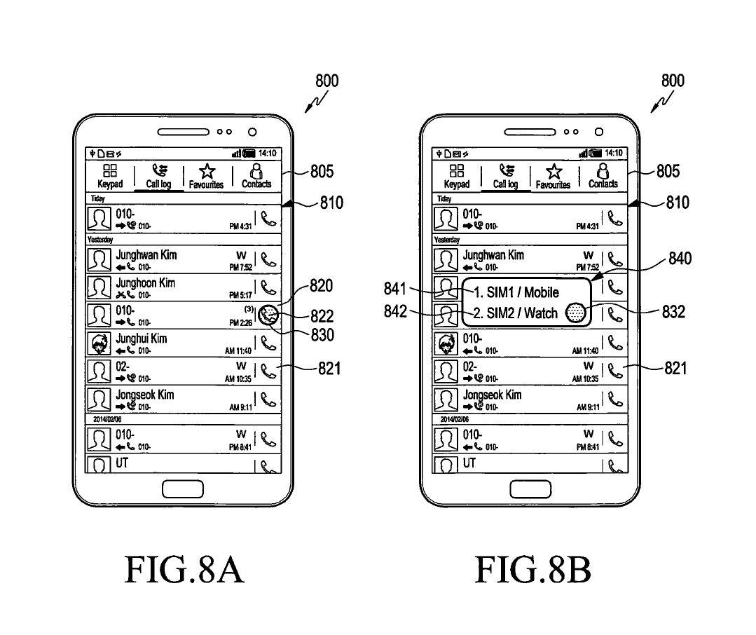

Referring to FIG. 8A, a call log screen 810 of a phone application is displayed on a display 805 of a first electronic device 800, and the call log screen 810 includes a plurality of items that may include at least one incoming/outgoing call log item 820 with respect to the first SIM and at least one incoming/outgoing call log item 821 with respect to the virtual second SIM. The call log item 821 with respect to the virtual second SIM may be highlighted. The highlighting includes visual highlighting, audible highlighting, and tactile highlighting. For example, visual highlighting is implemented by additionally displaying an icon, an image, or a text, or making a color, a shape, a transparency, or a position of the call log item 821 with respect to the virtual second SIM different from that of the call log item 820. In the current example, the call log item 821 with respect to the virtual second SIM is highlighted by additionally displaying an icon W.

According to an embodiment of the present disclosure, if the one-to-one communication connection between the first electronic device 800 and the second electronic device is released, the incoming/outgoing call log item 821 with respect to the virtual second SIM is deactivated or hidden.

The first screen portion 822 for receiving an input for communication may be the entire call log screen 810 or a portion thereof. For example, the first screen portion 822 is a call icon.

Upon detecting a user's selection of the first screen portion 822 of an arbitrary call log item (for example, the call log item 820 with respect to the first SIM) on the call log screen 810 illustrated in FIG. 8A, the first electronic device 800 displays a second screen portion 840 for designating at least one of the first SIM and the virtual second SIM as illustrated in FIG. 7B. The second screen portion 840 includes a first identifier (for example, SIM1/Mobile) corresponding to the first SIM and a second identifier (for example, SIM2/Watch) corresponding to the virtual second SIM. Each of the first and second identifiers may be displayed as contact information, a phone number, a name of a device or a module, a set text, or a set icon. The second screen portion 840 includes a selectable first item 841 including the first identifier and a selectable second item 842 including the second identifier. The user may designate a desired SIM by selecting one of the first and second items 841 and 842. For example, upon detecting a user's selection of the first item 841, the first electronic device 800 calls or sends a message to the third electronic device by using contact information of the first SIM (or the first electronic device 800) as a caller. As another example, upon detecting a selection 832 of the second item 842 by the user, the first electronic device 800 calls or sends a message to the third electronic device by using contact information of the virtual second SIM (or the second electronic device) as a caller.

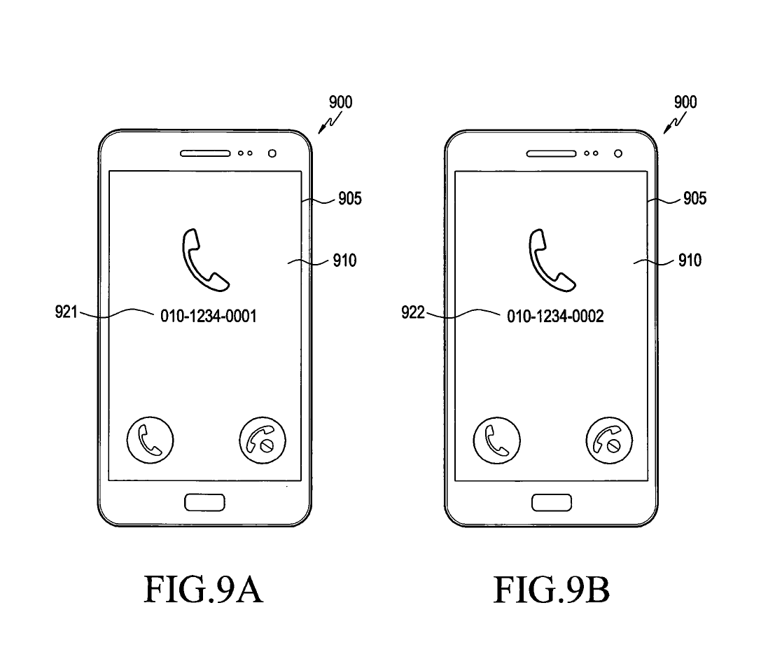

Referring to FIG. 9A, if the first electronic device calls a third electronic device 900 by using the contact information of the first SIM as a caller, an incoming call screen 910 of a phone application is displayed on a display 905 of the third electronic device 900 and contact information 921 of the first SIM (for example, a phone number “010-1234-0001” of the first electronic device stored in the first SIM) is displayed on the incoming call screen 910.

Referring to FIG. 9B, if the first electronic device calls the third electronic device 900 by using contact information of the virtual second SIM as a caller, the incoming call screen 910 of the phone application is displayed on the display 905 of the third electronic device 900 and the contact information 922 (for example, a phone number “010-1234-0002” of the second electronic device corresponding to the second SIM) of the virtual second SIM is displayed on the incoming call screen 910.

According to various embodiments of the present disclosure, a communication method for a first electronic device may include receiving second subscriber information stored in a second SIM of a second electronic device from the second electronic device, receiving second response information generated based on second authentication information from the second electronic device, and transmitting the second response information to a communication network.

According to various embodiments of the present disclosure, the communication method further includes establishing a communication connection between the first electronic device and the second electronic device, in which the first electronic device receives the second subscriber information from the second electronic device through the communication connection.

According to various embodiments of the present disclosure, the communication connection may be wireless communication connection or wired communication connection using BT, WiFi, WiFi Direct, BLE, NFC, Zigbee, or optical communication.

According to various embodiments of the present disclosure, the communication network may be a telephone network.

According to various embodiments of the present disclosure, the communication method further includes sending a request for the second subscriber information to the second electronic device.

According to various embodiments of the present disclosure, the communication method further includes detecting an event that requires the request for the second subscriber information, in which sending the request for the second subscriber information to the second electronic device is performed upon the detecting the event, and the event occurs based on a user input, a request of the second electronic device, a distance between the first electronic device and the second electronic device, the communication connection between the first electronic device and the second electronic device, or environment setting of the first electronic device.

According to various embodiments of the present disclosure, the communication method further includes receiving a notification for transmitting the second subscriber information from the second electronic device.

According to various embodiments of the present disclosure, the communication method further includes detecting an event that requires the notification for transmitting the second subscriber information, in which transmission of the notification is performed upon detecting the event, and the event occurs based on a user input, a distance between the first electronic device and the second electronic device, communication connection between the first electronic device and the second electronic device, or environment setting of the first electronic device.

According to various embodiments of the present disclosure, the communication method further includes transmitting at least a part of the second subscriber information to the communication network.

According to various embodiments of the present disclosure, the at least a part of the second subscriber information includes a phone number, a subscriber identification number, or an International Mobile Station Identity (IMSI) of the second subscriber corresponding to the second subscriber information.

According to various embodiments of the present disclosure, the communication method further includes receiving the second authentication information from the communication network and transmitting the second authentication information to the second electronic device.

According to various embodiments of the present disclosure, the communication method further includes receiving the second authentication information from the communication network and transmitting the second authentication information to the second electronic device, in which the second authentication information includes a first value, and the second response information includes a second value generated based on the first value.

According to various embodiments of the present disclosure, the communication method further includes transmitting at least a part of first subscriber information stored in a first SIM to the communication network.

According to various embodiments of the present disclosure, the communication method further includes transmitting at least a part of first subscriber information stored in a first SIM to the communication network, receiving first authentication information from the communication network, generating first response information based on the first authentication information, and transmitting the first response information to the communication network.

According to various embodiments of the present disclosure, the communication method further includes communicating with the communication network by using a phone number, a subscriber identification number, or an International Mobile Station Identity (IMSI) of a second subscriber corresponding to the second subscriber information.

According to various embodiments of the present disclosure, a first electronic device includes a communication module and a processor configured to receive second subscriber information stored in a second SIM of a second electronic device from the second electronic device by using the communication module, to receive second response information generated based on second authentication information from the second electronic device by using the communication module, and to transmit the second response information to a communication network by using the communication module.

According to various embodiments of the present disclosure, the processor is configured to establish a communication connection between the first electronic device and the second electronic device by using the communication module, and the first electronic device receives the second subscriber information from the second electronic device through the communication connection.

According to various embodiments of the present disclosure, the processor is configured to send a request for the second subscriber information to the second electronic device.

According to various embodiments of the present disclosure, the processor is configured to detect an event that requires the request for the second subscriber information and to send the request for the second subscriber information to the second electronic device upon detecting the event, and the event occurs based on a user input, a request of the second electronic device, a distance between the first electronic device and the second electronic device, the communication connection between the first electronic device and the second electronic device, or environment setting of the first electronic device.

According to various embodiments of the present disclosure, the processor is configured to receive a notification for transmitting the second subscriber information from the second electronic device by using the communication module.

According to various embodiments of the present disclosure, the processor is configured to transmit at least a part of the second subscriber information to the communication network by using the communication module.

According to various embodiments of the present disclosure, the processor is configured to receive the second authentication information from the communication network by using the communication module and to transmit the second authentication information to the second electronic device by using the communication module.

According to various embodiments of the present disclosure, the processor is configured to transmit at least a part of first subscriber information stored in a first SIM to the communication network by using the communication module.

According to various embodiments of the present disclosure, the processor is configured to transmit at least a part of first subscriber information stored in a first SIM to the communication network by using the communication module, to receive first authentication information from the communication network by using the communication module, to generate first response information based on the first authentication information, and to transmit the first response information to the communication network by using the communication module.

According to various embodiments of the present disclosure, a second electronic device includes a communication module and a processor configured to transmit subscriber information stored in a SIM of the second electronic device by using the communication module, to receive authentication information from the first electronic device or a communication network by using the communication module, to generate response information based on the authentication information, and to transmit the generated response information to the first electronic device.

According to various embodiments of the present disclosure, the processor is configured to establish a communication connection between the first electronic device and the second electronic device by using the communication module, and to transmit the subscriber information to the first electronic device through the communication connection.

According to various embodiments of the present disclosure, the processor is configured to receive a request for the subscriber information from the first electronic device by using the communication module.

According to various embodiments of the present disclosure, the processor is configured to transmit a notification for transmitting the subscriber information to the first electronic device by using the communication module.

According to various embodiments of the present disclosure, the communication module includes a first module configured to transmit the subscriber information and the response information to the first electronic device and a second module configured to communicate with the communication network, and the processor is configured to switch a state of the second module to an entire or partial power-off state, a reception-only state, or a periodic power-on/off state after transmitting the subscriber information to the first electronic device or after receiving the authentication information from the first electronic device.

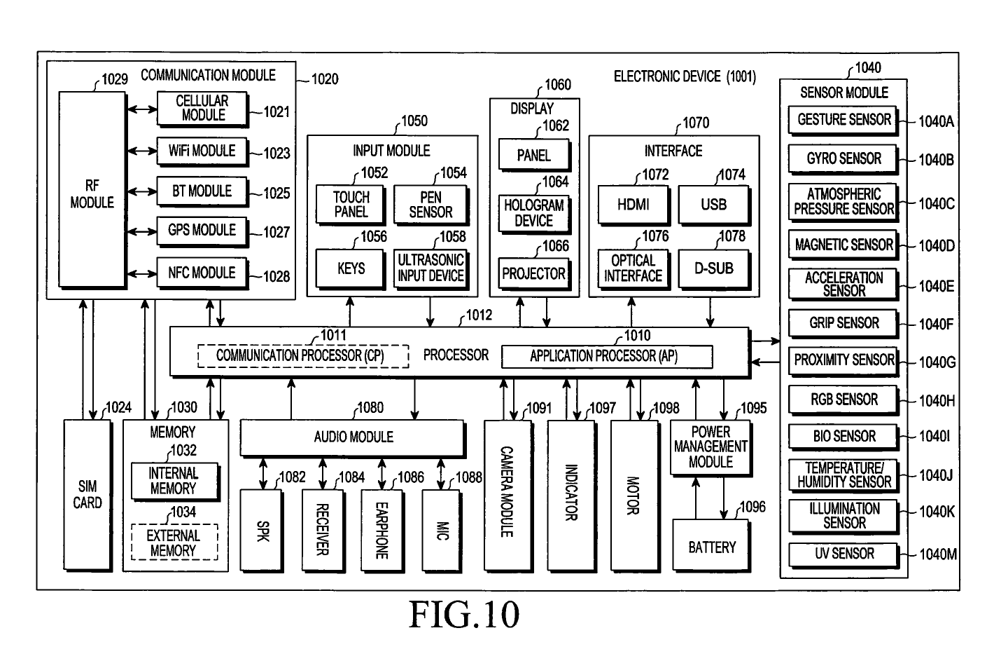

FIG. 10 is a block diagram of an electronic device 1001 according to an embodiment of the present disclosure. The electronic device 1001 constitutes the entire electronic device 101 illustrated in FIG. 1 or a portion thereof. Referring to FIG. 10, the electronic device 1001 includes at least one of a processor 1012 including one or more APs 1010 and/or one or more CPs 1011, a communication module 1020, an SIM card 1024, a memory 1030, a sensor module 1040, an input module 1050, a display 1060, an interface 1070, an audio module 1080, a camera module 1091, a power management module 1095, a battery 1096, an indicator 1097, and a motor 1098.

The AP 1010 drives an Operating System (OS) or an application program to control multiple hardware or software components connected to the AP 1010 and to perform processing and operations of various data including multimedia data. The AP 1010 may be implemented with, for example, a System on Chip (SoC). According to an embodiment of the present disclosure, the AP 1010 may further include a Graphic Processing Unit (GPU).

The communication module 1020 (for example, the communication interface 160 of FIG. 1) performs data transmission/reception in communication between the electronic device 1001 (for example, the electronic device 101 of FIG. 1) and other electronic devices (for example, the electronic device 104 or the server 106 of FIG. 1) connected through the network. According to an embodiment of the present disclosure, the communication module 1020 includes at least one of a cellular module 1021, a WiFi module 1023, a BT module 1025, a GPS module 1027, an NFC module 1028, and a Radio Frequency (RF) module 1029.

The cellular module 1021 provides at least one of voice communication, video communication, a messaging service, and an Internet service through a communication network (for example, LTE, LTE-A, CDMA, WCDMA, UMTS, WiBro, GSM, and/or the like). The cellular module 1021 identifies and authenticates an electronic device in a communication network by using a SIM (for example, the SIM card 1024). According to an embodiment of the present disclosure, the cellular module 1021 performs at least some of functions provided by the AP 1010. For example, the cellular module 1021 performs at least a part of a multimedia control function.

According to an embodiment of the present disclosure, the communication processor 1011 is included in the cellular module 1021. The cellular module 1021 may be implemented with, for example, a SoC. Although components such as the cellular module 1021 (for example, the communication processor 1011), the memory 1030, or the power management module 1095 are illustrated as being separated from the AP 1010, the AP 1010 may be implemented to include at least some of the foregoing components (for example, the cellular module 1021).

According to an embodiment of the present disclosure, the AP 1010 or the cellular module 1021 (for example, the cellular module 1021 including the CP 1011) loads a command or data received from at least one of a nonvolatile memory connected thereto and other components to a volatile memory and processes the received command or data. The AP 1010 or the cellular module 1021 stores data received from at least one of other components or data generated by at least one of other components in the nonvolatile memory.

Each of the WiFi module 1023, the BT module 1025, the GPS module 1027, and the NFC module 1028 includes a processor for processing data transmitted and received through the corresponding module. Although the cellular module 1021, the WiFi module 1023, the BT module 1025, the GPS module 1027, and the NFC module 1028 are illustrated as separate blocks in FIG. 8, at least some (for example, two or more) of the cellular module 1021, the WiFi module 1023, the BT module 1025, the GPS module 1027, and the NFC module 1028 may be included in one Integrated Chip (IC) or IC package. For example, at least some of processors corresponding to the cellular module 1021, the WiFi module 1023, the BT module 1025, the GPS module 1027, and the NFC module 1028 (for example, the CP 1011 corresponding to the cellular module 1021 and a WiFi processor corresponding to the WiFi module 1023) may be implemented in one SoC.

The RF module 1029 transmits and receives data, for example, a RF signal. The RF module 1029 includes, although not shown, at least one of a transceiver, a Power Amplification Module (PAM), a frequency filter, and a Low Noise Amplifier (LNA). The RF module 1029 may further include at least one of parts for transmitting and receiving electromagnetic waves on a free space, for example, a conductor and a conductive wire, in wireless communication. Although the cellular module 1021, the WiFi module 1023, the BT module 1025, the GPS module 1027, and the NFC module 1028 are illustrated as sharing one RF module 1029 in FIG. 10, at least one of the cellular module 1021, the WiFi module 1023, the BT module 1025, the GPS module 1027, and the NFC module 1028 may transmit and receive an RF signal through a separate RF module according to an embodiment of the present disclosure.

The SIM card 1024 is a card including a SIM, and may be inserted into a slot formed in a particular position of the electronic device. The SIM card 1024 includes unique identification information (for example, an ICCID) or subscriber information (for example, an IMSI).

The memory 1030 (for example, the memory 130) includes an internal memory 1032 or an external memory 1034. The internal memory 1032 includes at least one of a volatile memory (for example, a Dynamic Random Access Memory (DRAM), a Static RAM (SRAM), a Synchronous Dynamic RAM (SDRAM), and/or the like) and a nonvolatile memory (for example, One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and/or the like).

According to an embodiment of the present disclosure, the internal memory 1032 is a Solid State Drive (SSD). The external memory 1034 may further include a flash drive, for example, at least one of a compact flash, Secure Digital (SD), micro-SD, mini-SD, extreme digital (xD), and a memory stick. The external memory 1034 is functionally connected with the electronic device 1001 through various interfaces. According to an embodiment of the present disclosure, the electronic device 1001 may further include a storage device (or storage medium) such as a hard drive.

The sensor module 1040 measures a physical quantity or senses an operation state of the electronic device 1001 to convert the measured or sensed information into an electric signal. The sensor module 1040 includes at least one of a gesture sensor 1040A, a gyro sensor 1040B, an atmospheric pressure sensor 1040C, a magnetic sensor 1040D, an acceleration sensor 1040E, a grip sensor 1040F, a proximity sensor 10406, a color sensor 1040H (for example, Red, Green, Blue (RGB) sensor), a bio sensor 10401, a temperature/humidity sensor 1040J, an illumination sensor 1040K, an Ultra Violet (UV) sensor 1040M, and/or the like. Alternatively, the sensor module 1040 includes at least one of an E-nose sensor, an Electromyography (EMG) sensor, an Electroencephalogram (EEG) sensor, an Electrocardiogram (EGC) sensor, an Infrared (IR) sensor, an iris sensor, a fingerprint sensor, and/or the like. The sensor module 1040 may further include a control circuit for controlling at least one sensor included therein.

The input device 1050 includes a touch panel 1052, a (digital) pen sensor 1054, a key 1056, or an ultrasonic input device 1058. At least some components of the input device 1050 may be included in the input/output interface 140 illustrated in FIG. 1. The touch panel 1052 recognizes a touch input by using at least one of a capacitive, a resistive, infrared, or ultrasonic scheme. The touch panel 1052 may further include a control circuit. For the capacitive touch panel 1052, recognition of a physical contact or approach is possible. The touch panel 1052 may further include a tactile layer. In this case, the touch panel 1052 provides a tactile reaction to a user.

The (digital) pen sensor 1054 is implemented using a method that is the same as or similar to that of a user's touch input or by using a separate recognition sheet. The key 1056 includes a physical button, an optical key, or a keypad. The ultrasonic input device 1058 is a device that allows the electronic device 1001 to sense ultrasonic waves, to input using an input means that generates an ultrasonic signal, through a microphone (for example, a microphone 1088), and to check data. The ultrasonic input device 1058 is capable of performing wireless recognition. According to an embodiment of the present disclosure, the electronic device 1001 receives a user input from an external electronic device (for example, a computer or a server) connected thereto by using the communication module 1020.

The display 1060 (for example, the display 100 of FIG. 1) includes a panel 1062, a hologram device 1064, or a projector 1066. The panel 1062 may be, for example, a Liquid Crystal Display (LCD), an Active-Matrix Organic Light-Emitting Diode (OLED), and/or the like. The panel 1062 is implemented as being flexible, transparent, or wearable. The panel 1062 may be implemented with the touch panel 1052 as one module. The hologram device 1064 shows a stereoscopic image in the air by using interference of light. The projector 1066 projects light onto the screen to display an image. The screen is positioned inside or outside the electronic device 1001. According to an embodiment of the present disclosure, the display 1060 may further include a control circuit for controlling the panel 1062, the hologram device 1064, or the projector 1066.

The interface 1070 includes a High-Definition Multimedia Interface (HDMI) 1072, a Universal Serial Bus (USB) 1074, an optical interface 1076, or a D-subminiature (D-SUB) 1078. The interface 1070 may be included in the communication interface 160 illustrated in FIG. 1. Alternatively, the interface 1070 includes a Mobile High-definition Link (MHL) interface, an SD card/Multimedia Card (MMC) interface, or an infrared Data association (IrDA) standard interface.

The audio module 1080 bi-directionally converts sound and an electric signal. The audio module 1080 processes sound information input or output through at least one of a speaker SPK 1082, a receiver 1084, an earphone 1086, and the microphone MIC 1088. At least some of the audio module 1080, the speaker SPK 1082, the receiver 1084, the earphone 1086, and the microphone MIC 1088 may be included in the input/output interface 140 illustrated in FIG. 1.

The camera module 1091 is a device capable of capturing still and moving images, and according to an embodiment of the present disclosure, the camera module 1091 includes one or more image sensors (for example, a front sensor or a rear sensor), a lens, an Image Signal Processor (ISP), or a flash (for example, a Light Emitting Diode (LED) or a xenon lamp).

The power management module 1095 manages power of the electronic device 1001. Although not shown, a Power Management Integrated Circuit (PMIC), a charger IC, or a battery or fuel gauge may be included in the power management module 1095.

The PMIC may be mounted in, for example, an IC or a SoC semiconductor. The charging method is classified into a wired type and a wireless type. The charger IC charges a battery, and prevents introduction of an over-voltage or over-current from a charger. According to an embodiment of the present disclosure, the charger IC includes a charger IC for at least one of a wired charging method and a wireless charging method. The wireless charging method includes, for example, a magnetic resonance method, a magnetic induction method, or an electromagnetic wave method, and an additional circuit for wireless charging, for example, a coil loop, a resonance circuit, or a rectifier may be added for the wireless charging method.

The battery gauge measures the remaining capacity of the battery 1096, and a voltage, a current, or a temperature of the battery 1096 during charging. The battery 1096 stores or produces electricity and supplies power to the electronic device 1001 by using the stored or produced electricity. The battery 1096 may include a rechargeable battery or a solar battery.

The indicator 1097 displays a particular state, for example, at least one of a booting state, a message state, and a charging state, of the electronic device 1001 or a part thereof (for example, the AP 1010). The motor 1098 converts an electric signal into mechanical vibration. The indicator 1097 and the motor 1098 may be included in the input/output interface 140 illustrated in FIG. 1. Although not shown, a processing unit for supporting mobile TVs (for example, a Graphic Processing Unit (GPU)) may be included in the electronic device 1001. The processing unit for supporting mobile TVs processes media data complying with, for example, Digital Multimedia Broadcasting (DMB), Digital Video Broadcasting (DVB), or a media flow.

According to various embodiments of the present disclosure, the user may communicate with another electronic device at a phone number of a desired electronic device by using one electronic device.

The foregoing components of the electronic device according to various embodiments of the present disclosure may include one or more components, and a name of a component may vary according to a type of the electronic device. The electronic device according to various embodiments of the present disclosure may include at least one of the foregoing components, and some of them may be omitted from the electronic device or other components may be further included in the electronic device. Also, some of the components of the electronic device according to various embodiments of the present disclosure may be combined into one entity to perform the same function as those of the components that have not been combined.

According to various embodiments of the present disclosure, at least a part of a device (for example, modules or functions thereof) or a method (for example, operations) according to various embodiments of the present disclosure may be implemented with a command stored in, for example, a computer-readable storage medium in the form of a programming module. When the command is executed by one or more processors (for example, the processor 120 of FIG. 1), the one or more processors may perform a function corresponding to the command. The computer-readable storage medium may be, for example, the memory 130 of FIG. 1. At least a part of the programming module may be implemented (for example, executed) by the processor 120 of FIG. 1. At least a part of the programming module may include at least one of a module, a program, a routine, sets of instructions, and a process to perform one or more functions.

The computer-readable storage medium may include magnetic media such as a hard disk, a floppy disk, and a magnetic tape optical media such as a Compact Disc Read Only Memory (CD-ROM) and a Digital Versatile Disc (DVD), magneto-optical media such as a floptical disk, and a hardware device specially configured to store and execute a program command (for example, a programming module) such as a Read Only Memory (ROM), a Random Access Memory (RAM), and a flash memory. The program command may include not only a mechanical language code generated by a compiler, but also a high-level language code that may be executed by a computer using an interpreter. The hardware device may be configured to operate as one or more software modules for performing operations according to various embodiments of the present disclosure or vice versa.

A module or programming module according to various embodiments of the present disclosure may include at least one of the foregoing components, or some of the foregoing components may be omitted or other components may be further included. Operations executed by a module, a programming module, or other components according to various embodiments of the present disclosure may be performed sequentially, in parallel, repetitively, or heuristically. Some operations may be executed in another order or may be omitted, or other operations may be added.

According to various embodiments of the present disclosure, in a storage medium storing commands, the commands are set to control at least one processor to perform at least one operation when executed by the at least one processor, and the at least one operation may include receiving second subscriber information stored in a second SIM of a second electronic device from the second electronic device, receiving second response information generated based on second authentication information from the second electronic device, and transmitting the second response information to the communication network.

Various embodiments of the present disclosure disclosed in the specification and the drawings merely provide a particular example in order to easily describe the technical content of the present disclosure and to facilitate the understanding of the present disclosure, and are not intended to limit the scope of the present disclosure. It will be understood by those skilled in the art that various changes and modifications may be made without departing from the spirit and scope of the disclosure as defined in the following claims and their equivalents.

What is claimed is:

1. A communication method for a first electronic device, the communication method comprising:
receiving, from a second electronic device, second subscriber information stored in a second subscriber identification module of the second electronic device;
receiving second response information generated based on second authentication information from the second electronic device; and
transmitting the second response information to a communication network.

2. The communication method of claim 1, further comprising:
detecting an event that requires sending a request for the second subscriber information;
sending the request for the second subscriber information to the second electronic device upon detecting the event, and
wherein the event occurs based on one of a user input, a request of the second electronic device, a distance between the first electronic device and the second electronic device, the communication connection between the first electronic device and the second electronic device, and an environment setting of the first electronic device.

3. The communication method of claim 1, further comprising receiving a notification for transmitting the second subscriber information from the second electronic device.

4. The communication method of claim 1, further comprising transmitting at least a part of the second subscriber information to the communication network,
wherein the at least a part of the second subscriber information comprises one of a phone number, a subscriber identification number, and an International Mobile Station Identity (IMSI) of a second subscriber corresponding to the second subscriber information.

5. The communication method of claim 1, further comprising:
receiving the second authentication information from the communication network; and
transmitting the second authentication information to the second electronic device,
wherein the second authentication information comprises a first value, and the second response information comprises a second value generated based on the first value.

6. The communication method of claim 1, further comprising:
transmitting at least a part of first subscriber information stored in a first subscriber identification module to the communication network;
receiving first authentication information from the communication network;
generating first response information based on the first authentication information; and
transmitting the first response information to the communication network.

7. The communication method of claim 1, further comprising communicating with the communication network by using one of a phone number, a subscriber identification number, and an International Mobile Station Identity (IMSI) of a second subscriber corresponding to the second subscriber information.

8. A non-transitory machine-readable recording medium having recorded thereon a program for executing a communication method for a first electronic device, the communication method comprising:
receiving, from a second electronic device, second subscriber information stored in a second subscriber identification module of the second electronic device;
receiving second response information generated based on second authentication information from the second electronic device; and
transmitting the second response information to a communication network.

9. A first electronic device comprising:
a communication module; and
a processor configured to receive, from a second electronic device, second subscriber information stored in a second subscriber identification module of the second electronic device using the communication module, to receive second response information generated based on second authentication information from the second electronic device using the communication module, and to transmit the second response information to a communication network using the communication module.

10. The first electronic device of claim 9, wherein the processor is configured to send a request for the second subscriber information to the second electronic device.

11. The first electronic device of claim 10, wherein the processor is configured to detect an event that requires the request for the second subscriber information and to send the request for the second subscriber information to the second electronic device upon detecting the event, and
wherein the event occurs based on one of a user input, a request of the second electronic device, a distance between the first electronic device and the second electronic device, the communication connection between the first electronic device and the second electronic device, and an environment setting of the first electronic device.

12. The first electronic device of claim 9, wherein the processor is configured to receive a notification for transmitting the second subscriber information from the second electronic device using the communication module.

13. The first electronic device of claim 9, wherein the processor is configured to transmit at least a part of the second subscriber information to the communication network by using the communication module.

14. The first electronic device of claim 9, wherein the processor is configured to receive the second authentication information from the communication network using the communication module and to transmit the second authentication information to the second electronic device using the communication module.

15. The first electronic device of claim 9, wherein the processor is configured to transmit at least a part of first subscriber information stored in a first subscriber identification module to the communication network using the communication module.

16. The first electronic device of claim 9, wherein the processor is configured to transmit at least a part of first subscriber information stored in a first subscriber identification module to the communication network using the communication module, to receive first authentication information from the communication network by using the communication module, to generate first response information based on the first authentication information, and to transmit the first response information to the communication network using the communication module.

17. A second electronic device comprising:
a communication module; and
a processor configured to transmit subscriber information stored in a subscriber identification module of the second electronic device using the communication module, to receive authentication information from a first electronic device or a communication network using the communication module, to generate response information based on the authentication information, and to transmit the generated response information to the first electronic device.

18. The second electronic device of claim 17, wherein the processor is configured to receive a request for the subscriber information from the first electronic device using the communication module.

19. The second electronic device of claim 17, wherein the processor is configured to transmit a notification for transmitting the subscriber information to the first electronic device using the communication module.

20. The second electronic device of claim 17, wherein the communication module comprises:
a first module configured to transmit the subscriber information and the response information to the first electronic device; and
a second module configured to communicate with the communication network,
wherein the processor is configured to switch a state of the second module to an entire or partial power-off state, a reception-only state, or a periodic power-on/off state after transmitting the subscriber information to the first electronic device or after receiving the authentication information from the first electronic device.
